(19) United States
(12) Patent Application Publication
(10) Pub. No.: US 2018/0247465 A1
(43) Pub. Date: Aug. 30, 2018

(54) METHODS AND SYSTEMS FOR OFFERING UNIVERSAL ACCESS TO MASS TRANSIT SYSTEMS USING MOBILE DEVICES

(71) Applicant: MasterCard International Incorporated, Purchase, NY (US)

(72) Inventors: Felipe Lopez Alaniz, Pinecrest, FL (US); Jorge Martin Zamora, Parkland, FL (US); Cesar Espinoza, Pinecrest, FL (US); Javier Krysztal, Miami, FL (US)

(21) Appl. No.: 15/445,473

(22) Filed: Feb. 28, 2017

(51) Int. Cl. G07B 15/00; G06Q 20/32

(52) U.S. Cl. CPC G07B 15/00; G06Q 20/322

(57) ABSTRACT

A method includes storing at least three mutually different transit terminal transaction protocols in a server computer. A first request is received from a mobile device. In response to the request, a first one of the transit terminal transaction protocols is downloaded from the server computer to the mobile device. A second request is received from the mobile device. In response to the second request, a second one of the transit terminal transaction protocols is downloaded from the server computer to the mobile device.

### BACKGROUND

In some cities, there are two or more public mass transit systems that do not share a common mode of payment. It is not uncommon in such cities for passengers/users to carry a number of different integrated circuit (IC) payment cards, with each of the user's cards dedicated for use in obtaining entry to a different one of the transit systems. In some systems, these cards are essentially stored value cards in which adequate funds must be currently available when the user seeks entry to the transit system. Aside from the inconvenience of carrying multiple cards, some users also face financial liquidity issues with respect to their transit access cards. That is, some users of transit systems have low incomes and find it difficult to maintain adequate balances on the cards to satisfy their daily needs for access to the transit systems for their daily commutes and other travel via mass transit. Because of personal budgetary constraints, some users need to engage in frequent top-up transactions for their transit access cards so that they do not have an excessive proportion of their available financial resources tied up on their transit cards.

A further issue faced by transit users is that it is virtually inevitable, with current arrangements that their transit card or cards will not work when they travel from their home city to another city and seek to use the transit system(s) there.

### BRIEF DESCRIPTION OF THE DRAWINGS

Features and advantages of some embodiments of the present disclosure, and the manner in which the same are accomplished, will become more readily apparent upon consideration of the following detailed description of the invention taken in conjunction with the accompanying drawings, which illustrate preferred and example embodiments and which are not necessarily drawn to scale, wherein:

FIG. 1 is a block diagram that shows aspects of a conventional payment account system.

FIG. 2 is a diagram that schematically illustrates a mass transit system entrance transaction in connection with which aspects of the present disclosure may be applied.

FIG. 3 is a diagram that schematically depicts a transit access system according to aspects of this disclosure.

FIG. 4 is block diagram of a typical mobile device shown in FIG. 3 and provided in accordance with teachings of this disclosure

FIG. 5 schematically illustrates some aspects of the mobile device of FIG. 4.

FIGS. 6 and 7 are block diagrams of computer systems that may be part of the system of FIG. 3.

FIGS. 8, 9 and 10 are flow diagrams that illustrate processes performed in accordance with teachings of this disclosure.

### DESCRIPTION

In general, and for the purpose of introducing concepts of embodiments of the present disclosure, a payment-enabled mobile device may be used to enter a number of different transit systems which use incompatible, “closed-loop” payment systems. A central database stores downloadable digital material (hereinafter referred to as “protocols”) that may be used to control a short-range signaling (e.g., NFC—near field communication) capability of the mobile device so that it is able to engage in entry transactions with the transit entry terminals/payment systems of the various transit systems. (A protocol may include one or more scripts, processing routines, data, parameters, flags and/or other resources that may be necessary to allow an application program to control the NFC functionality of the mobile device to emulate the functionality of a dedicated contactless IC transit access card for a particular transit system.) A different protocol is downloaded to/stored in the mobile device for each of the closed-loop systems to be transacted with, and is invoked by the user when seeking entry into the corresponding transit system.

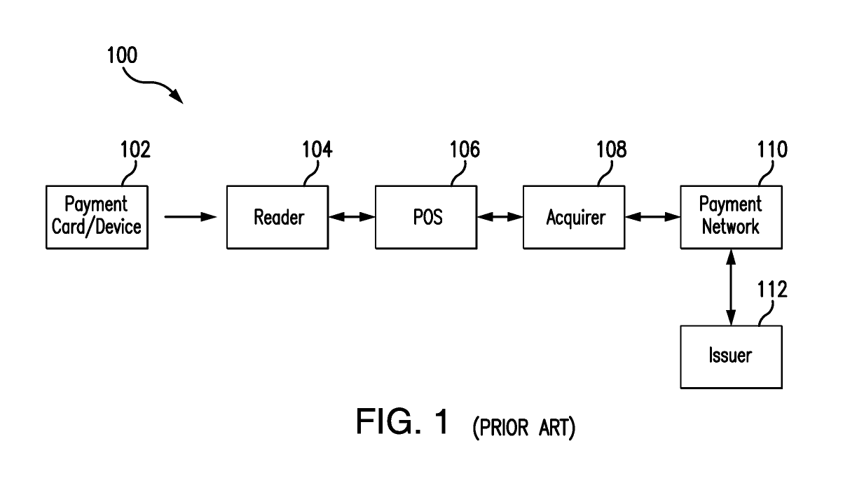

Initially, by way of background, aspects of a conventional payment account system will now be described with reference to FIG. 1.

FIG. 1 is a block diagram of a conventional payment system 100.

The system 100 includes a conventional payment card/device 102. Item 102 may be, for example, a magnetic stripe or IC (integrated circuit) payment card, or a payment-enabled mobile device that stores credentials for one or more payment accounts. The system 100 further includes a reader component 104 associated with a POS terminal 106. In some known manner (depending on the type of the payment device 102) the reader component 104 is capable of reading the payment account number and other information from the payment device 102.

The reader component 104 and the POS terminal 106 may be located at the premises of a retail store/merchant and operated by a sales associate of the merchant for the purpose of processing retail transactions.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment account issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated proximity reader components. The system may also include a very large number of payment account holders, who carry payment devices for initiating payment transactions by presenting a payment account number to the reader component of a POS terminal.

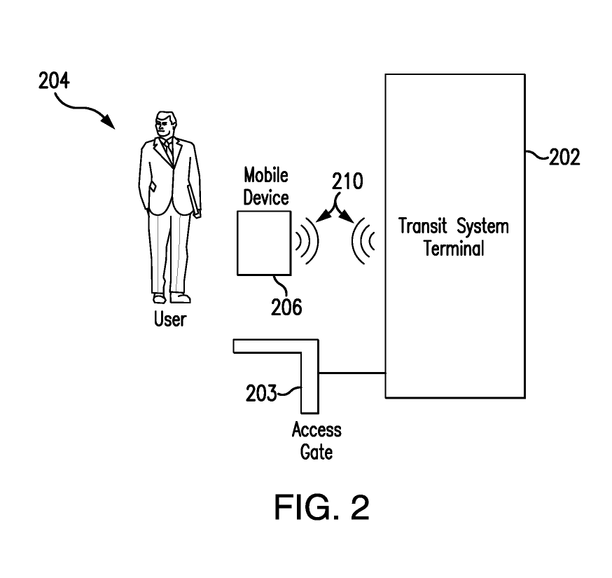

Reference is now made to FIG. 2 which is a schematic illustration of an example environment in which aspects of the present disclosure may be applied. More specifically, FIG. 2 is a diagram that schematically illustrates a mass transit system entrance transaction in connection with which aspects of the present disclosure may be applied.

In FIG. 2, a transit system terminal 202 is shown. The transit system terminal 202 may alternatively be referred to as a “transit system transaction terminal” or “transit system contactless transaction terminal” in the sense that the terminal 202 may engage in “transactions” with devices such as contactless IC cards, payment-enabled mobile devices, etc. The term “transaction” should be understood to refer to any exchange of data between the transit system terminal 202 and another device in which the other device identifies the holder of the device and/or indicates that the holder is entitled to enter the transit system and/or arrangements are made for payment to obtain the holder's entrance into the payment system. An entry gate 203 (also referred to as an “access gate”) to the transit system is operatively coupled to the transit system terminal 202 and is under control of the transit system terminal 202. In some embodiments, the transit system terminal 202 may be physically integrated with the entry gate 203. In accordance with previous discussion, it is assumed that the transit system terminal 202 operates in accordance with the transaction processes of a “closed-loop” payment system—i.e., a system that does not support payment transactions of the type described above in connection with FIG. 1. The latter type of transactions are sometimes referred to as “open-loop” transactions in that they can be performed with general purpose payment account devices.

Also shown in FIG. 2 is an individual user 204 who is carrying a payment-enabled mobile device 206. An exchange of short-range radio communications between the payment-enabled mobile device 206 and the transit system terminal 202 is schematically illustrated at 210.

Although FIG. 2 depicts an environment for permitting the user to access a rail-based underground and/or elevated mass transit system, at least some aspects of the present disclosure may also be applicable to transit system terminals operated on buses, trolleys, trams, etc. to secure or confirm payment for access to vehicles of those kinds.

In general, operation of the transit system terminal 202 may resemble operation of a typical transit system terminal. However, it may be in accordance with aspects of the present disclosure that arrangements are made whereby the mobile device 206 is programmed to have capabilities for interacting with the transit system terminal 202.

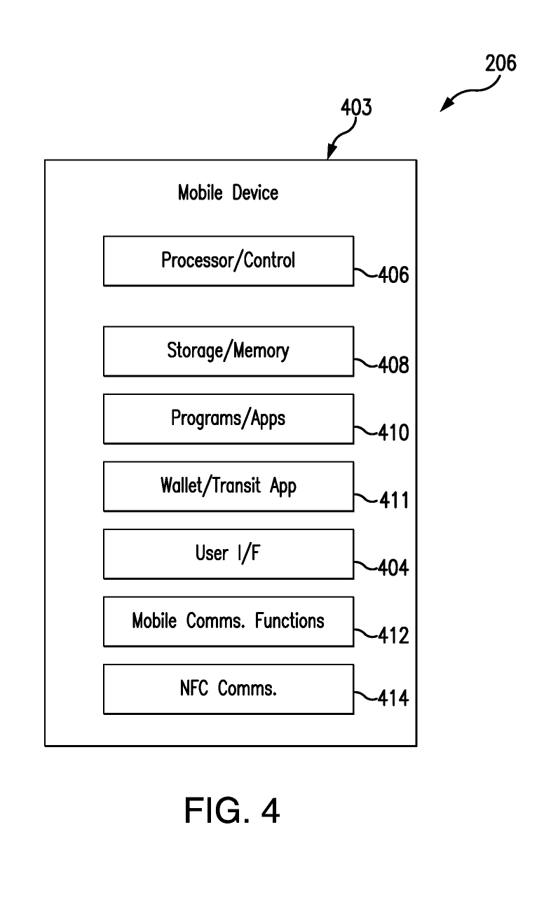

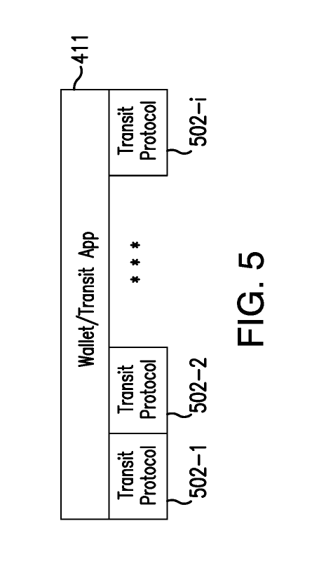

Further details of the mobile device 206 will be provided in later portions of this document, including the below discussions of FIGS. 4 and 5.

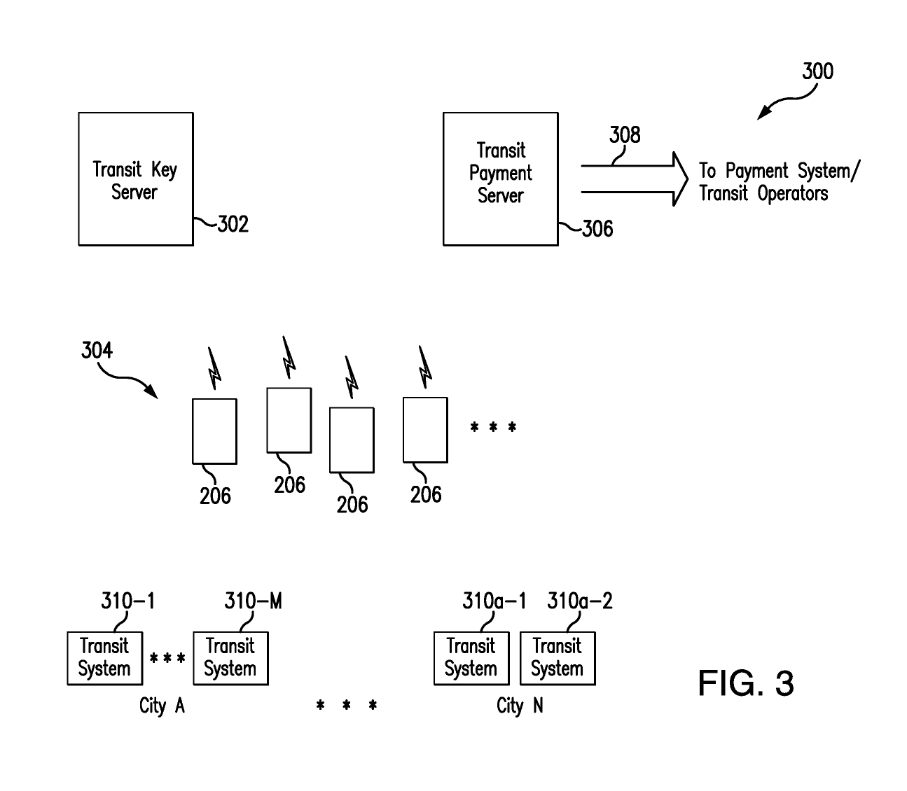

Reference will first be made, however, to FIG. 3. FIG. 3 is a diagram that schematically depicts a transit access system 300 according to aspects of this disclosure.

One salient feature of the transit access system 300 is a transit key server computer 302. As will be seen from subsequent discussion, the transit key server computer 302 is a repository of, and provides a distribution function for, transit access protocols to be supplied to numerous mobile devices 206, shown schematically at 304 in FIG. 3.

Another salient feature of the transit access system 300 is a transit payment server computer 306. As discussed in more detail below, the transit payment server computer 306 facilitates transactions in which mobile devices 206 are “topped up” with monetary credit, paid-up subscription status or the like, and the users' payments for these top-up transactions are forwarded to the relevant transit system operators, as schematically illustrated at 308.

It is assumed that the transit access system 300 provides its functionality in connection with numerous transit systems spread over a wide geographical area, and even globally. Thus, as schematically illustrated in FIG. 3, the protocols stored in the transit key server computer 302 may be relevant to transit systems 310-1 to 310-M in “City A” and to other transit systems in numerous other cities, including transit systems 310a-1 and 310a-2 in “City N”.

FIG. 4 is a block diagram of an example embodiment of a mobile device 206 as shown in FIG. 2 or 3; the mobile device 206 is provided in accordance with teachings of this disclosure.

The mobile device 206 may include a housing 403. In many embodiments, the front of the housing 403 is predominantly constituted by a touchscreen (not separately shown), which is a key element of the user interface 404 of the mobile device 206.

The mobile device 206 further includes a mobile processor/control circuit 406, which is contained within the housing 403. Also included in the mobile device 206 is a storage/memory device or devices (reference numeral 408). The storage/memory devices 408 are in communication with the processor/control circuit 406 and may contain program instructions to control the processor/control circuit 406 to manage and perform various functions of the mobile device 206. As is well-known, a device such as mobile device 206 may function as what is in effect a pocket-sized personal computer (assuming for example that the mobile device is a smartphone), via programming with a number of application programs, or “apps,” as well as a mobile operating system (OS). (The apps are represented at block 410 in FIG. 4, and may, along with other programs, in practice be stored in block 408, to program the processor/control circuit 406.)

Also shown in FIG. 4 is a wallet/transit app 411. The wallet/transit app 411 is shown apart from the other apps represented at block 410, in part due to the particular relevance of the wallet/transit app 411 to the subject of this disclosure. In addition, the separate representation of the wallet/transit app 411 also may be considered to represent the possibility that it is stored in a secured element or “SE” (not shown apart from block 411 or block 408), which may be provided in some embodiments of the mobile device 206 to provide enhanced security for the wallet/transit app 411 and/or sensitive data associated therewith. The SE, if present, may be conventional in its hardware aspects. In addition or alternatively, security for the wallet/transit app 411 may be enhanced by known alternatives to an SE, such as a TEE (trusted execution environment).

To the extent that the SE includes processing capabilities, it may functionally (though likely not physically) overlap with block 406; to the extent that the SE includes storage (and particularly program storage) capabilities, it may functionally (though likely not physically) overlap with block 408.

In some embodiments, the wallet/transit app 411 may resemble a typical wallet app as previously proposed for or implemented in payment-enabled mobile devices. However, the wallet/transit app 411 may also, in accordance with teachings of this disclosure, have further capabilities as described herein. To briefly describe those capabilities, the wallet/transit app 411 may receive and have associated with it various transit terminal communication protocols as downloaded to the mobile device 206 from the transit key server computer 302. In addition, the wallet/transit app 411 may utilize/be guided by protocols associated therewith in order to engage in transit entry transactions with transit access terminals. FIG. 5 schematically illustrates a number of previously downloaded transit protocols 502 stored in the mobile device 206 (not explicitly indicated in FIG. 5) in association with the wallet/transit app 411.

Referring again to FIG. 4, and as is typical for mobile devices, the mobile device 206 may include mobile communications functions as represented by block 412. The mobile communications functions may include voice and data communications via a mobile communication network (not shown) with which the mobile device 206 is registered. For example, downloads of protocols from the transit key server computer 302 to the mobile device 206 may be carried out, at least in part, via the above-mentioned mobile communication network.

In addition, to facilitate use as a device for providing transit access to its user (and possibly also to facilitate use for contactless payment transactions in general), the mobile device 206 may include short-range radio communications capabilities (block 414), including for example NFC (near field communication). Thus block 414 may represent a suitable antenna (not separately shown) that is appropriate for NFC communications as well as driving and receiving circuitry associated with the antenna. It will be appreciated that the NFC antenna may be separate and different from the antenna (not separately shown) utilized by the mobile device 206 for the mobile communication functions represented by block 412.

From the foregoing discussion, it will be appreciated that the blocks depicted in FIG. 4 as components of the mobile device 206 may in effect overlap with each other, and/or there may be functional connections among the blocks which are not explicitly shown in the drawing. It may also be assumed that, like a typical smartphone, the mobile device 206 may include a rechargeable battery (not shown) that is contained within the housing 403 and that provides electrical power to the active components of the mobile device 206.

It has been posited that the mobile device 206 may be embodied as a smartphone, but this assumption is not intended to be limiting, as mobile device 206 may alternatively, in at least some cases, be constituted by a tablet computer, smartwatch or by other types of portable electronic devices.

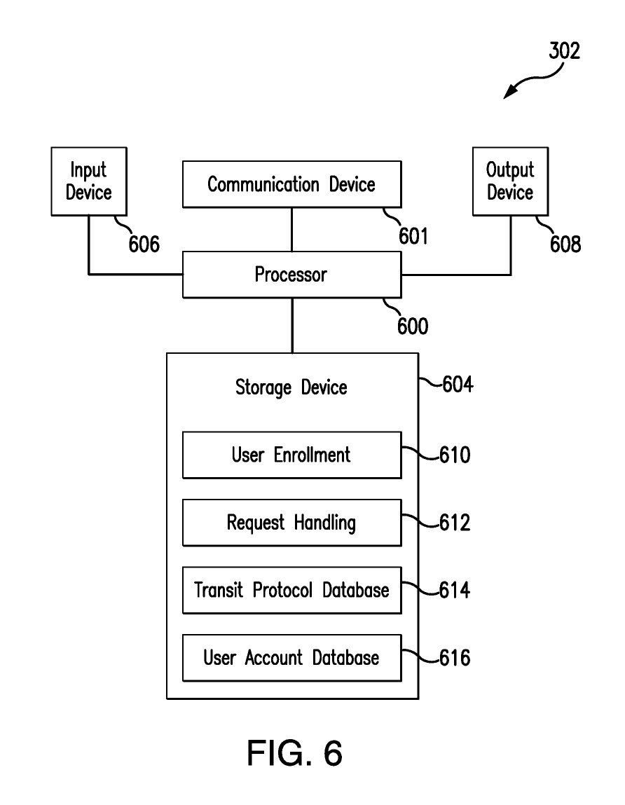

FIG. 6 is a block diagram representation of an embodiment of the transit key server computer 302 shown in FIG. 3.

In some embodiments, hardware aspects of the transit key server computer 302 may be constituted by typical server computer hardware, but may be controlled by software to cause it to function as described herein.

The transit key server computer 302 may include a processor 600 operatively coupled to a communication device 601, a storage device 604, an input device 606 and an output device 608. The communication device 601, the storage device 604, the input device 606 and the output device 608 may all be in communication with the processor 600.

The processor 600 may be constituted by one or more processors. The processor 600 may operate to execute processor-executable steps, contained in program instructions described below, so as to control the transit key server computer 302 to provide desired functionality.

Communication device 601 may be used to facilitate communication with, for example, other devices (such as users' smartphones). For example, communication device 601 may comprise numerous communication ports (not separately shown), to allow the transit key server computer 302 to respond simultaneously to numerous attempts to communicate with the transit key server computer 302.

Input device 606 may comprise one or more of any type of peripheral device typically used to input data into a computer. For example, the input device 606 may include a keyboard and a mouse. Output device 608 may comprise, for example, a display and/or a printer.

Storage device 604 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 604 stores one or more programs for controlling processor 600. The programs comprise program instructions (which may be referred to as computer readable program code means) that contain processor-executable process steps of the transit key server computer 302, executed by the processor 600 to cause the transit key server computer 302 to function as described herein.

The programs may include one or more conventional operating systems (not shown) that control the processor 600 so as to manage and coordinate activities and sharing of resources in the transit key server computer 302, and to serve as a host for application programs (described below) that run on the transit key server computer 302.

The programs stored in the storage device 604 may also include a user enrollment application program 610 that controls the processor 600 to support functionality of the transit key server computer 302 to allow users to register user accounts with the transit key server computer 302.

The storage device 604 may also store a request handling application program 612 that controls the processor 600 to permit the transit key server computer 302 to handle requests from users (i.e., from their mobile devices 206) for downloads of the protocols for enabling the mobile devices 206 to engage in entry transactions with the transit entry terminals of particular transit systems.

The storage device 604 may also store, and the transit key server computer 302 may also execute, other programs, which are not shown. For example, such programs may include (a) web hosting software, which enables the transit key server computer 302 to maintain a website for access by users via their mobile devices and/or other computing devices, and (b) a reporting application, which may respond to requests from system administrators for reports on the activities performed by the transit key server computer 302. The other programs may also include, e.g., device drivers, database management programs, communications software, etc.

In some embodiments, the storage device 604 may also store a database 614 of transit protocols available for download from the transit key server computer 302, and a database 616 that stores user account data. The storage device 604 may also store one or more other databases (not shown) that may also be needed or helpful for operation of the transit key server computer 302.

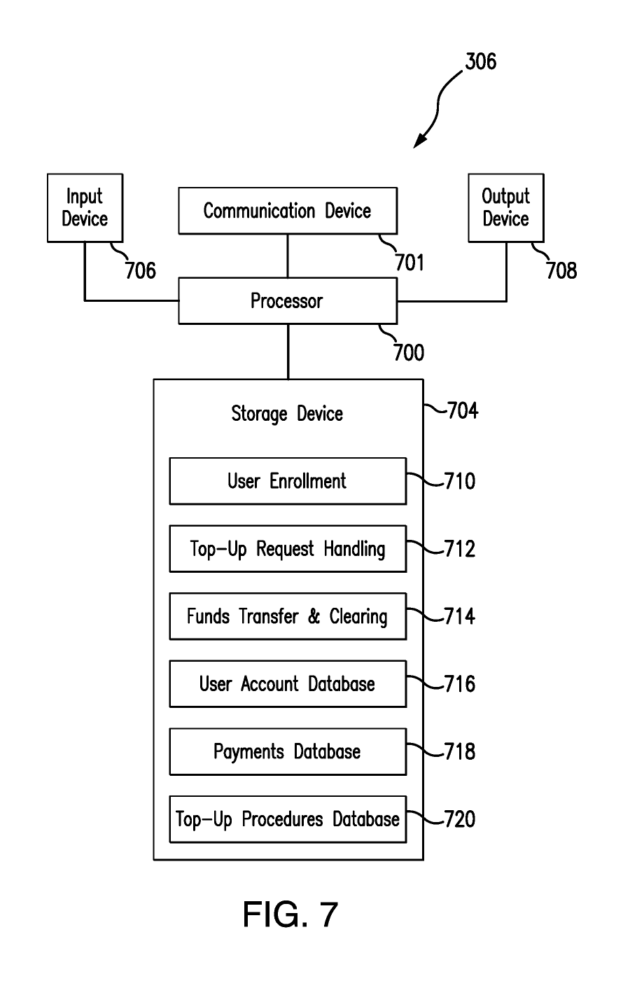

FIG. 7 is a block diagram representation of an embodiment of the transit payment server computer 306 shown in FIG. 3.

In its hardware architecture and components, the transit payment server computer 306 may, for example, resemble the hardware architecture and components described above in connection with FIG. 6. However, the transit payment server computer 306 may be programmed differently from the transit key server computer 302 so as to provide different functionality.

Returning again to the hardware aspects of the transit payment server computer 306, it may include a processor 700, a communication device 701, a storage device 704, an input device 706 and an output device 708. The communication device 701, the storage device 704, the input device 706 and the output device 708 may all be in communication with the processor 700.

The above descriptions of the hardware components shown in FIG. 6 may, in some embodiments, also be applicable to the like-named components shown in FIG. 7.

Storage device 704 stores one or more programs for controlling processor 700. The programs comprise program instructions (which may be referred to as computer readable program code means) that contain processor-executable process steps of the transit payment server computer 306, executed by the processor 700 to cause the transit payment server computer 306 to function as described herein.

The programs may include one or more conventional operating systems (not shown) that control the processor 700 so as to manage and coordinate activities and sharing of resources in the transit payment server computer 306, and to serve as a host for application programs (described below) that run on the transit payment server computer 306.

The programs stored in the storage device 704 may also include a user enrollment application program 710 that controls the processor 700 to support functionality of the transit payment server computer 306 to allow users to register user accounts with the transit payment server computer 306.

Further, the storage device 704 may store a request handling program 712 that handles top-up requests. The top-up requests may be submitted from mobile devices 206 to the transit payment server computer 306 to obtain recharging of value and/or subscription status in the mobile devices to enable the mobile devices to facilitate further entry transactions with transit entry terminals.

In addition, the storage device 704 may store a funds transfer and clearing application program 714 to enable the transit payment server computer 306 to handle forwarding and clearing of payments from users to the transit system operators of the transit systems for which the users will wish to seek access. In short, the transit payment server computer 306 may serve as a focal point for receipt and processing of payments from users and distribution of those payments to the appropriate transit systems selected by the users.

The storage device 704 may also store, and the transit payment server computer 306 may also execute, other programs, which are not shown. For example, such programs may include (a) web hosting software, which enables the transit payment server computer 306 to maintain a website for access by users via their mobile devices and/or other computing devices, and (b) a reporting application, which may respond to requests from system administrators for reports on the activities performed by the transit payment server computer 306. The other programs may also include, e.g., device drivers, database management programs, communications software, etc.

In some embodiments, the storage device 704 may also store a database 716 of user account data. In some embodiments, the user account data may include payment account information in a card-on-file arrangement so that user top-up requests are funded through payment account system transactions using the “card on file” user payment account information.

In a further database (reference numeral 718), the storage device 704 may store data records pertaining to payments received by the transit payment server computer 306 and/or dispatched or due to be dispatched to transit system operators. In still a further database (reference numeral 720) that may be stored in the storage device 704, data may be stored to guide the transit payment server computer 306 in terms of what top-up procedures may be applicable or available with respect to each of the transit system operators that participate in the system 300 (FIG. 3). Continuing to refer to FIG. 7, the storage device 704 may also store one or more other databases (not shown) that may also be needed or helpful for operation of the transit payment server computer 306.

Although the transit key server computer 302 and the transit payment server computer 306 may been depicted and described above as separate computer systems, nevertheless in some embodiments they may at least partially overlap with each other and/or may share the same hardware and some software resources and/or may be substantially integrated with each other.

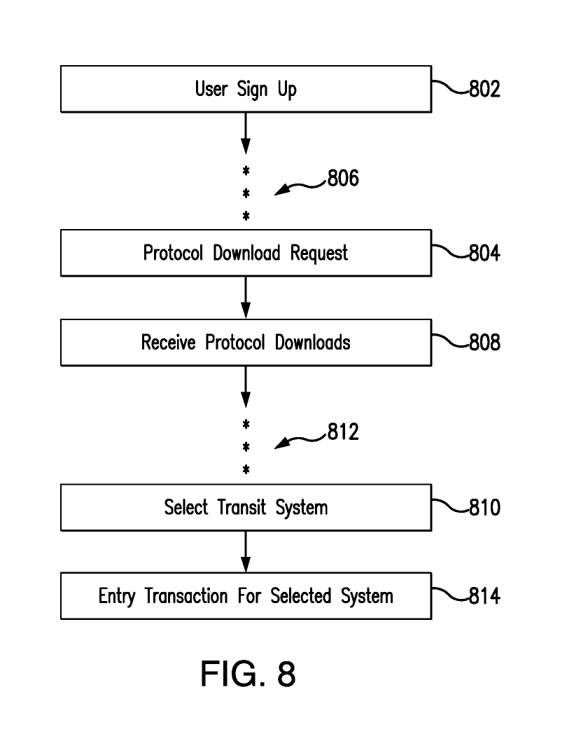

FIG. 8 is a flow chart that represents a process that may be performed according to aspects of the present disclosure.

At 802 in FIG. 8, a user of one of the mobile devices 206 may engage in a sign-up/enrollment procedure. This may involve the user interacting with either or both of the transit key server computer 302 and the transit payment server computer 306 via the user's mobile device 206. During such interaction, the user may open a user account at either or both of the transit key server computer 302 and the transit payment server computer 306. The user account at either or both of the transit key server computer 302 and the transit payment server computer 306 may include identifying and/or contact information for the user and identifying information for the user's mobile device. In some embodiments, this process step may occur after or in conjunction with the user having downloaded the wallet/transit app 411 to his/her mobile device 206. As suggested by previous discussion, the user account at the transit payment server computer 306 may store card-on-file information for the user (i.e., the user's payment account number and related information needed for a transaction akin to the transaction illustrated in FIG. 1).

In the process of FIG. 8, process step 804 may follow 802, and this may occur after a lapse of time, as indicated by ellipsis 806. At 804, the user's mobile device 206 may operate and/or may be operated by the user to request a download of one or more protocols from the transit key server computer 302. In some embodiments, the user may simply actuate a “request protocol” function made available to him/her via the wallet/transit app 411 on the mobile device 206. The wallet/transit app 411 may determine (e.g., based on input from another app on the mobile device 206) where (i.e., in what city) the mobile device is currently located. The wallet/transit app 411 may include this “current city” information in the request sent to the transit key server computer 302 from the mobile device 206.

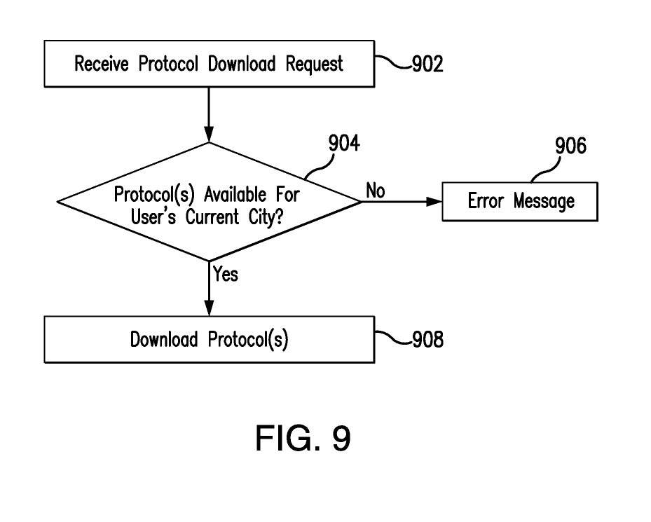

In some embodiments, the “request protocol” function of the wallet/transit app 411 may be automatically triggered in the mobile device 206 (without user actuation) (a) immediately on completion of sign-up (block 902 in FIG. 9) and/or (b) each time that the mobile device 206 determines that it has been transported into a city where it previously has not been located or for which transit entry protocols have not previously been requested by the mobile device 206. In other embodiments, or in other situations, the request transmitted to the transit key server computer 302 at 804 may specify a particular transit system for which the relevant protocol is requested, instead of or in addition to specifying the city.

Block 808 in FIG. 8 may follow block 804. At block 808, the mobile device 206 may receive a download or downloads of one or more protocols from the transit key server computer 302. The protocol(s) downloaded at 808 may correspond to the current city specified in the request at 804. The protocol(s) downloaded may be all of those available in the transit key server computer 302 for the city in question (i.e., for all transit operators in the city from which protocols have been made available to the transit key server computer 302).

Block 810 may follow block 808, after some delay or intervening events, as indicated by ellipsis 812. The occasion for block 810 may be when the user of the mobile device 206 is about to seek entry to one of the transit systems for which a protocol has been downloaded to the mobile device 206. At block 810, the user may operate the mobile device 206 to indicate to the mobile device 206 the user's selection of an option presented by the mobile device 206 (e.g., via the wallet/transit app 411), where the selected option corresponds to the transit system that the user is about to enter. The user's selection of the option may trigger the wallet/transit app 411 to access the protocol (as stored in the mobile device 206) that corresponds to the transit system in question. Thus, in effect, the user has selected the appropriate protocol for the transit system that he/she is about to enter. Then, at 814, the mobile device 206 may utilize the selected protocol to engage in a transit system entry transaction, as schematically illustrated in FIG. 2 (discussed above). The selected protocol enables the mobile device 206 to operate its NFC functionality in a manner that emulates a contactless transit entry card or similar device that may otherwise be utilized to engage in a transit entry transaction with the transit system terminal and that is compatible with/dedicated to the particular transit system.

When the user selects a particular transit system as described in the previous paragraph, the selection may be made from a menu of options (each option a different transit system) presented to the user by the wallet/transit app 411 via the user interface of the mobile device 206. The wallet/transit app 411 may select the options to be presented based on which city the mobile device 206 is currently located in. That is, the options presented may be limited to transit systems that operate in the mobile device's current location-city. Also, the options presented may be further limited to systems for which protocols have previously been downloaded to the mobile device 206/wallet/transit app 411.

In some transit systems, payment for the use of the system may be at a flat rate upon entry to the system. The mobile device 206 in such cases may function as a stored value device, with a suitable amount of the value being deducted from the stored value in the mobile device during the transit entry transaction.

In addition or alternatively, the transit system may offer monthly or weekly fare prepayment options (which may be referred to as “subscription” options, and which may alternatively be for time periods other than a week or month). In such a case, the transaction between the transit entry terminal and the mobile device 206 may confirm that the mobile device stores data that evidences a subscription for the current time period.

In other transit systems, the per-ride charge may depend on distance traveled or zones traversed or the like. In such systems, the initial entry transaction merely indicates the starting point of the trip, and the user/rider is again required to engage in a transaction with a transit system terminal upon exiting from the transit system at the end of the ride. It is at the latter transaction that the fare for the ride is determined, and the corresponding amount deducted from the value stored in the mobile device 206. It will be appreciated that systems of this type may also offer weekly or monthly subscriptions or the like, or one- or five-day unlimited riding arrangements, etc., as an alternative to pay-by-the-ride.

FIG. 9 is another flow chart that illustrates a process that may be performed according to teachings of this disclosure.

At 902 in FIG. 9, the transit key server computer 302 (FIG. 3) may receive a request for a download of a protocol or protocols from one of the transit-enabled mobile devices 206. In a typical embodiment, the request—in addition to identifying the particular mobile device that is making the request—may also specify the current location (by city) of the mobile device 206. In effect, then, the request may be for all protocols that correspond to transit systems operating in the city in which the mobile device is currently located; the request thus may specify the city, but not an individual transit system or protocol therefor. Alternatively, the request may specify a particular transit system for which the relevant protocol is requested, instead of or in addition to specifying the city.

A decision block 904 may follow block 902 in the process of FIG. 9. At decision block 904, the transit key server computer 302 may determine whether it has stored and available for download any protocols relevant to transit systems in the city specified in the request received at 902. If not, then block 906 (an error message or the like) may follow decision block 904.

However, if a positive determination is made at decision block 902 (i.e., if the transit key server computer 302 determines that it has one or more protocols available for download that correspond to a transit system or systems in the indicated city), then block 908 may follow decision block 904. At block 908, the transit key server computer 302 may download the relevant protocol(s) to the mobile device 206. In some embodiments, the transit key server computer 302 may download all available protocols for the indicated city.

It should be noted that the process of FIG. 9 may occur upon the user originally downloading and activating the wallet/transit app 411 to his/her mobile device 206 while the user is located in his/her home city. In addition or alternatively, the process of FIG. 9 may occur when the user has traveled to another city and desires to obtain transit-related entry protocols for the city in which he/she has just arrived. The request referred to in block 902 may occur in response to the user initiating the request via an interaction by the user with the mobile device 206. Alternatively, the request referred to in block 902 may be automatically generated by the wallet/transit app 411 in the mobile device 206 upon the mobile device detecting that it has been transported to or is in a city for which it has not previously obtained the relevant transit-related protocols.

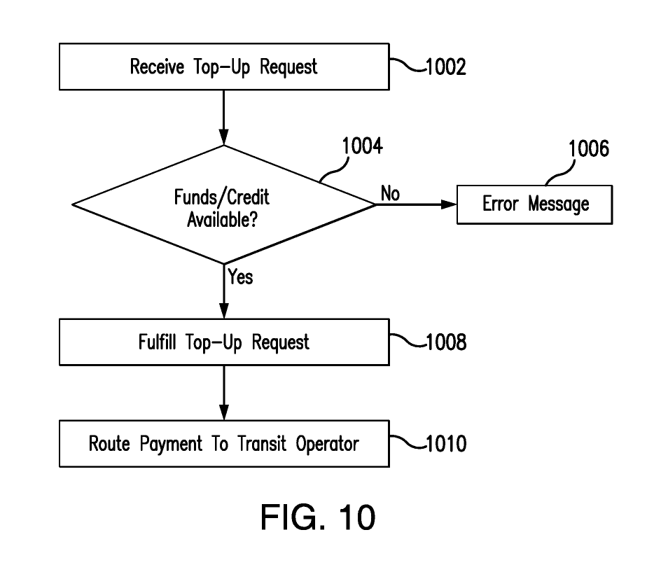

FIG. 10 is still another flow chart that illustrates a process that may be performed according to teachings of this disclosure.

At 1002 in FIG. 10, the transit payment server computer 306 may receive, from a mobile device 206, a request for a top-up transaction. As used herein and in the appended claims, a “top-up” should be understood to mean a loading of value into the mobile device 206 for use in transit entry transactions or a loading into the mobile device of an indication that the user has purchased a “subscription” (as referred to above), such as a monthly ticket, a weekly ticket, a one-, three- or five-day pass, etc. A typical request of this kind may include data that identifies the requesting mobile device 206 and/or the user, and may provide access to the user's account maintained in the transit payment server computer 306. In some embodiments, the top-up transaction may be funded via a “card on file” payment account system transaction. In such a transaction, the transit payment server computer 306 may play the role that was represented by the merchant in the typical payment account transaction illustrated in FIG. 1. That is, the transit payment server computer 306 may initiate a payment account transaction authorization request message in order to provide funding for a top-up via a charge to a debit, credit or prepaid account or other payment system account that belongs to the user of the mobile device 206 and that is represented by an account number and other account information stored for the user in the transit payment server computer 306. A typical request may specify the transit system for which the top-up is requested. The request may also specify the type of top-up requested (e.g., a load of monetary value or a subscription of some kind).

A decision block 1004 may follow block 1002. At decision block 1004, it is determined whether the payment account transaction to fund the top-up was approved. That is, for example, it may be determined whether there were adequate funds or credit in the user's payment account to support the transaction, or whether the transit payment server computer 306 received an approval message for the transaction. If not, an error message or the like may be issued, as indicated at block 1006.

If a positive determination is made at decision block 1004 (i.e., if the funding payment account system transaction is approved), then block 1008 may follow decision block 1004.

At block 1008, the transit payment server computer 306 may exchange data messages with the mobile device 206 so as to effectuate the requested top-up, thereby loading monetary value or a subscription indicator into the mobile device 206.

Block 1010 in FIG. 10 may follow block 1008. At block 1010, the transit payment server computer 306 may arrange to transfer the payment received for the top-up to the transit system operator for which the top-up was requested. It will be appreciated that the payment transfer to the transit system operator may be bundled/batched with other payments for the same operator and in some arrangements may be net of a fee. It may be the case that this payment arrangement may be more cost efficient for the transit system operator than typical current arrangements in which the transit system operator contracts with a payment system contractor to handle the payment aspects of the transit operation.

With a transit access system as illustrated in FIG. 3 and as further described in connection with others of the drawing figures, a user of multiple transit systems may find payment for and access to the transit systems to be considerably more convenient, with access available via a single device (e.g., the user's smartphone) and with handling of funding for transit access also readily manageable through the same device. With top-up funding via, e.g., a credit account accessed via the transit payment server computer, money management may also be simplified for the user. It is also contemplated that the system described herein may span continents, or indeed may be global, and may enable travelers to use their mobile devices as transit access devices in cities that they happen to visit. The computer systems shown in FIG. 3 may be located anywhere in the world (and/or may be implemented in a distributed manner), and the transit systems schematically represented in FIG. 3 may also be located in any city, including cities on the same or different continents in which the computer systems are located.

In some embodiments, upon the wallet/transit app 411 being downloaded to the mobile device 206, the transit key server 302 may thereafter automatically download to the mobile device 206 all of the relevant transit protocols 502 (plus updates thereof) for each city in which the mobile device is located from time to time. To support this functionality, the mobile device 206 may report its current location to the transit key server 302 at the time of downloading the wallet/transit app 411 and may update the transit key server on the mobile device's current location each time the mobile device is transported to another city.

Although the embodiments as described above have referred to a mobile device such as a smartphone as being the device used for transit access, in other embodiments it may be the case that other wearable devices (e.g., smartwatches) may perform that role.

In other alternative embodiments, instead of or in addition to a conventional transit terminal, the point of access to a transit system may feature a fixedly installed smartphone or the like. The latter device may have biometric reading capabilities such as a thumb/fingerprint scanner or a retinal scanner, and may allow users to identifying themselves biometrically to obtain entrance to the transit system. In response to detecting the individual's biometric characteristic, the transit system may use a “card on file” or prepaid balance arrangement to support obtaining payment for the user's access to the transit system.

As used herein and in the appended claims, the term “sponsor” refers to a transit system operator that operates a transit system to which a particular protocol in relevant.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The above descriptions and illustrations of processes herein should not be considered to imply a fixed order for performing the process steps. Rather, the process steps may be performed in any order that is practicable, including simultaneous performance of at least some steps.

Although the present disclosure has been set forth in relation to specific example embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
storing a plurality of mutually different transit terminal transaction protocols in a server computer;
receiving a first request from a mobile device;
in response to the first request, downloading a first one of the transit terminal transaction protocols from the server computer to the mobile device;
receiving a second request from the mobile device; and
in response to the second request, downloading a second one of the transit terminal transaction protocols from the server computer to the mobile device.

2. The method of claim 1, wherein each of said transit terminal transaction protocols is for controlling an NFC (near field communication) function on the mobile device.

3. The method of claim 1, further comprising:
receiving, at a payment computer, a first top-up request from the mobile device; and
fulfilling the first top-up request to enable payment of transit terminal transactions in accordance with said downloaded first one of the transit terminal transaction protocols.

4. The method of claim 3, further comprising:
receiving, at a payment computer, a second top-up request from the mobile device; and
fulfilling the second top-up request to enable payment of transit terminal transactions in accordance with said downloaded second one of the transit terminal transaction protocols.

5. The method of claim 4, further comprising:
dispatching a first payment to a sponsor of the downloaded first one of the transit terminal transaction protocols, said first payment pertaining to said fulfilling of the first top-up request.

6. The method of claim 5, further comprising:
dispatching a second payment to a sponsor of the downloaded second one of the transit terminal transaction protocols, said second payment pertaining to said fulfilling of the second top-up request.

7. The method of claim 6, wherein said first and second payments are made via a payment account system.

8. The method of claim 1, further comprising:
receiving an indication of a current location of the mobile device; and
based on said current location, responding to said first request by downloading at least two of said transit terminal transaction protocols, said at least two of said transit terminal transaction protocols corresponding to said current location of the mobile device.

9. The method of claim 1, wherein said first request includes an indication of a current location of the mobile device.

10. A method comprising:
entering a city while carrying a mobile device;
launching a transit access application program stored in the mobile device; and
receiving, from a server computer, a plurality of transit terminal transaction protocols, each of said protocols corresponding to a respective one of a plurality of transit systems, said transit systems operating in said city.

11. The method of claim 10, wherein the server computer is not located in said city.

12. The method of claim 10, wherein the city in located in a first continent, said server computer located in a second continent different from the first continent.

13. The method of claim 10, wherein each of said transit terminal transaction protocols is for controlling an NFC (near field communication) function on the mobile device.

14. The method of claim 10, further comprising:
sending, to a payment computer, a first top-up request from the mobile device; and
receiving a first top-up in the mobile device, to enable payment of transit terminal transactions in accordance with a first one of the transit terminal transaction protocols.

15. The method of claim 14, further comprising:
sending, to a payment computer, a second top-up request from the mobile device; and
receiving a second top-up in the mobile device, to enable payment of transit terminal transactions in accordance with a second one of the transit terminal transaction protocols, said second of the transit terminal transaction protocols different from said first one of the transit terminal transaction protocols.

16. A method comprising:
storing a plurality of mutually different transit terminal transaction protocols in a server computer;
receiving, by the server computer, an indication of a city in which a mobile device is currently located;
in response to said indication, determining, by the server computer, at least two of said transit terminal transaction protocols, each respectively corresponding to a respective one of a plurality of transit systems operated in said city, said transit systems mutually different from each other; and
downloading the determined at least two of said transit terminal transaction protocols to the mobile device from the server computer.

17. The method of claim 16, wherein each of said transit terminal transaction protocols is for controlling an NFC (near field communication) function on the mobile device.

18. The method of claim 16, further comprising:
receiving, at a payment computer, a first top-up request from the mobile device; and
fulfilling the first top-up request to enable payment of transit terminal transactions in accordance with a first one of said downloaded transit terminal transaction protocols.

19. The method of claim 18, further comprising:
receiving, at a payment computer, a second top-up request from the mobile device; and
fulfilling the second top-up request to enable payment of transit terminal transactions in accordance with a second one of said downloaded transit terminal transaction protocols, said second one of said downloaded transit terminal transaction protocols different from said first one of said downloaded transit terminal transaction protocols.

20. The method of claim 19, further comprising:
dispatching a payment to a sponsor of said first one of the downloaded transit terminal transaction protocols, said dispatched payment pertaining to said fulfilling of the first top-up request.
